(19) United States
(12) Patent Application Publication
(10) Pub. No.: US 2015/0134200 A1
(43) Pub. Date: May 14, 2015

(54) APPARATUS FOR PERFORMING SPECIFIC TASK OF VEHICLE AND METHOD OF CONTROLLING THE SAME

(71) Applicant: HYUNDAI MOTOR COMPANY, Seoul (KR)

(72) Inventor: Yeon Ji KIM, Seoul (KR)

(21) Appl. No.: 14/534,144

(22) Filed: Nov. 5, 2014

(30) Foreign Application Priority Data
Nov. 8, 2013 (KR) 10-2013-0135531

(51) Int. Cl. G06F 3/0488; G06F 3/0484; G01S 19/13; G06F 3/041; B60H 1/00; G01C 21/36

(52) U.S. Cl. CPC G06F 3/04883; B60H 1/00985; G01C 21/36; G01S 19/13; G06F 3/0416; G06F 3/0484
USPC 701/36; 701/1

(57) ABSTRACT

A vehicle includes an input configured to receive a touch signal input by a user. A controller is configured to determine whether the input touch signal continues for a reference time or more and execute a specific task corresponding to the input touch signal when the input touch signal continues for the reference time or more.

### CROSS-REFERENCE TO RELATED APPLICATION

This application claims the benefit of priority to Korean Patent Application No. P2013-135531 filed on Nov. 8, 2013 in the Korean Intellectual Property Office, the disclosure of which is incorporated herein by reference.

### TECHNICAL FIELD

The present disclosure relates to an apparatus for performing a specific task in a vehicle according to a touch signal input of a user and a method of controlling the same.

### BACKGROUND

A wide range of IT technologies have been developed in a vehicle with various functions for user convenience in addition to a basic driving function.

Specifically, the vehicle may perform the various functions for user convenience, such as an audio function of outputting a sound through a speaker, a video function of outputting an image through a display, a navigation function of showing a driving path to a desired destination, a calling function of making or receiving a call using a mobile communication terminal held by a user, and the like.

As more functions are performed in the vehicle, the user manipulation load on devices are increased, a driver gets distracted from driving, and unexperienced drivers may have difficulty manipulating the devices while driving.

### SUMMARY

The present disclosure provides an apparatus for performing a specific task in a vehicle capable of immediately executing the task that is frequently used by a user or necessary for emergency situations by recognizing a simple touch signal, and a method of controlling the same.

According to an exemplary embodiment of the present disclosure, an apparatus for performing a specific task in a vehicle includes an input configured to receive a touch signal inputted by a user. A controller is configured to determine whether the receiving of the input touch signal continues for a reference time or more and to execute the specific task corresponding to the input touch signal when the receiving of the input touch signal continues for the reference time or more.

The vehicle may further include a display and the input includes a touch screen configured to receive the touch signal.

The vehicle may further include a communication module configured to connect the controller and a mobile communication terminal. The controller may execute a specific task corresponding to the input touch signal using the mobile communication terminal.

The communication specific task corresponding to the input touch signal may include calling a predetermined number.

The vehicle may further include an air conditioner configured to control a temperature in the vehicle. The controller may execute a specific task corresponding to the input touch signal using the air conditioner.

The temperature specific task corresponding to the input touch signal may include controlling the temperature in the vehicle to a predetermined temperature.

The vehicle may further include a radio module comprising a receiver configured to receive radio waves and a tuner configured to separate the radio waves corresponding to a specific channel from the received radio waves. A speaker is configured to output a sound signal which is separated from the radio waves corresponding to the specific channel. The controller may execute a specific task corresponding to the input touch signal using the radio module.

The radio specific task corresponding to the input touch signal may include controlling the tuner such that the radio waves corresponding to a predetermined channel are separated.

The vehicle may further include a driving path generator configured to generate a driving path from a departure position to a destination. The controller may guide the vehicle according to the generated driving path and execute a specific task corresponding to the input touch signal using the driving path generator.

The specific task corresponding to the input touch signal may include a task of generating a driving path from the departure position to a predetermined destination and guiding the vehicle according to the generated driving path.

The display may display at least one of an audio screen, a video screen, and a navigation screen. The controller may control the display such that the specific task corresponding to the input touch signal is executed.

The specific task corresponding to the input touch signal may include a task of displaying at least one screen of the audio screen, the video screen, and the navigation screen.

The controller may differently map a task according to the number of input touch signals.

According to another exemplary embodiment of the present disclosure, a method of controlling a vehicle includes receiving a touch signal inputted by a driver. Whether the receiving of the input touch signal continues for a predetermined reference time or more is determined. A task corresponding to the input touch signal is executed when the receiving of the input touch signal continues for the reference time or more.

The touch signal may be inputted through a touch screen.

The task corresponding to the input touch signal may include a task of calling a predetermined number using a mobile communication terminal that is paired with the vehicle. The predetermined number may include at least one of 911, the most recently called number, and an insurance company number.

The task corresponding to the input touch signal may include a control task of controlling a temperature in the vehicle to a predetermined temperature. The task corresponding to the input touch signal may include a task of outputting the radio corresponding to a predetermined channel through a speaker included in the vehicle. The task corresponding to the input touch signal may include a task of generating a driving path from a departure position to a predetermined destination and guiding the vehicle according to the generated driving path. The task corresponding to the input touch signal may include a task of displaying at least one predetermined screen of an audio screen, a video screen, and a navigation screen on a display.

The method may further include mapping and storing a specific touch signal with a specific task, wherein, when the input touch signal continues for the reference time or more, it may be determined as the specific touch signal.

The mapping and storing of the specific touch signal with the specific task may include, according to the number of touch signals forming the specific touch signal, differently mapping a specific task corresponding thereto.

### BRIEF DESCRIPTION OF THE DRAWINGS

These and/or other aspects of the invention will become apparent and more readily appreciated from the following description of the embodiments, taken in conjunction with the accompanying drawings.

FIG. 1 is a diagram illustrating an outer appearance of a vehicle according to an embodiment of the present disclosure.

FIG. 2 is a control block diagram of an apparatus for performing a specific task of the vehicle according to the embodiment of the present invention.

FIG. 3 is a diagram illustrating an internal configuration of the vehicle having the apparatus for performing a specific task according to the embodiment of the present invention, wherein a display unit is provided in the vehicle.

FIG. 4 is a diagram illustrating an exemplary input of a touch signal through the display unit in the vehicle according to the embodiment of the present disclosure.

FIG. 5 is a control block diagram of an apparatus for performing a specific task of a vehicle according to an embodiment of the present disclosure, wherein a specific touch signal is mapped with a specific task in the vehicle.

FIGS. 6(a) to 10 are diagrams illustrating exemplary screens displayed on the display unit when the specific touch signal is mapped with the specific task.

FIG. 11 is a control block diagram of an apparatus for performing a specific task of a vehicle according to an embodiment of the present disclosure that can make a call using a mobile communication terminal in the vehicle.

FIG. 12 is a control block diagram of an apparatus for performing a specific task of a vehicle according to an embodiment of the present disclosure that can control a temperature in the vehicle.

FIG. 13 is a control block diagram of an apparatus for performing a specific task of a vehicle according to an embodiment of the present disclosure that can output radio in the vehicle.

FIG. 14 is a control block diagram of an apparatus for performing a specific task of a vehicle according to an embodiment of the present disclosure that performs a navigation function in the vehicle.

FIG. 15 is a flowchart illustrating a method of controlling an apparatus for performing a specific task of a vehicle according to an embodiment of the present disclosure.

FIG. 16 is a flowchart in which a specific touch signal is mapped with a specific task by a user in the method of controlling an apparatus for performing a specific task of a vehicle according to an embodiment of the present disclosure.

### DETAILED DESCRIPTION

Hereinafter, a vehicle and a method of controlling the same according to embodiments of the present disclosure will be described in detail with reference to the accompanying drawings.

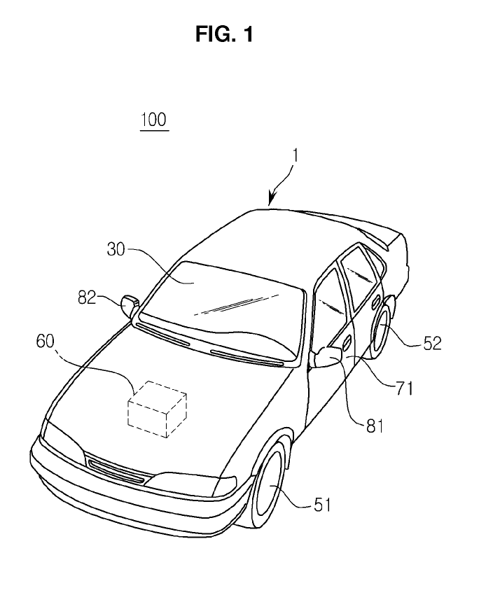

FIG. 1 is a diagram illustrating an appearance of a vehicle seen from the outside according to an embodiment of the present disclosure.

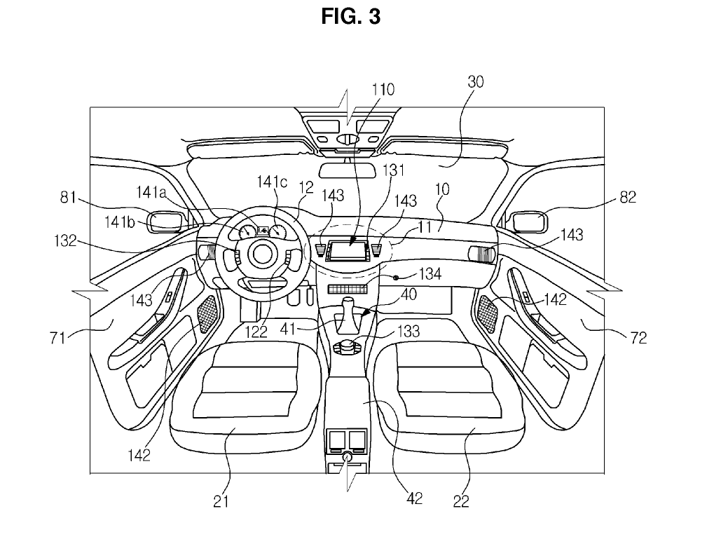

As illustrated in FIG. 1, a vehicle 100 according to the embodiment of the present disclosure includes a main body 1 forming an appearance of the vehicle 100, front and rear wheels 51 and 52 moving the vehicle 100, a driving unit 60 rotating the wheels 51 and 52, doors 71 and 72 (refer to FIG. 3) shielding the inside of the vehicle 100, a front glass 30 providing a front field of view of the vehicle 100 to a driver, and left and right side mirrors 81 and 82 providing a rear field of view of the vehicle 100.

The front wheels 51 are disposed at a front side of the vehicle 100 and the rear wheels 52 are disposed at a rear side of the vehicle 100. The driving unit 60 provides rotary power to the front wheels 51 or the rear wheels 52 such that the main body 1 moves forward or backward. The driving unit 60 may include a combustion engine (not illustrated) generating rotary power or a motor receiving power from a condenser (not illustrated) to generate power.

The doors 71 and 72 are pivotally provided on left and right sides of the main body 1. The doors allow the driver to enter and exit the vehicle 100. When the doors are closed, the doors shield the inside of the vehicle 100 from the outside.

The front glass 30 or also known as a windshield glass is provided at an upper front side of the main body 1 to provide the front view to the driver.

The left side mirror 81 is provided on the left side of the main body 1, and the right side mirror 82 is provided on a right side thereof to provide the side and rear views to the driver.

The vehicle 100 may further include a detecting device such as a proximity sensor configured to detect a rear obstacle or other vehicles, and a rain sensor configured to detect rainfall and precipitation.

The proximity sensor may transmit a detection signal to sides or rear of the vehicle and receive a reflection signal reflected from an obstacle such as other vehicles. The obstacle at the sides or rear of the vehicle 100 may be detected, and a location of the obstacle may be detected based on a waveform of the received reflection signal. As an example of such a proximity sensor, a method in which an ultrasound is transmitted and a distance to the obstacle is detected using an ultrasound reflected from the obstacle may be used.

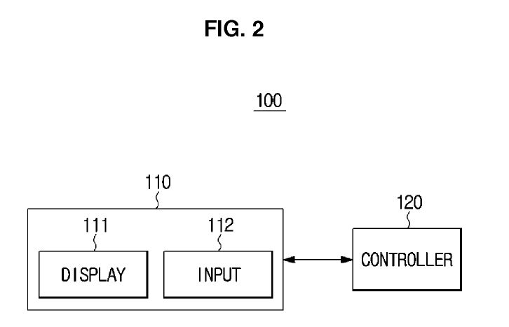

FIG. 2 is a control block diagram of an apparatus for performing a specific task of a vehicle according to an embodiment of the present disclosure.

As illustrated in FIG. 2, the apparatus for performing a specific task of the vehicle 100 includes a display unit 110 configured to display a screen for providing specific information to a user and receive a touch signal input by the user. A controller 120 is configured to execute a specific task corresponding to the input touch signal when the input touch signal continues for a reference time or more.

The display unit 110 may be implemented by a touch screen. Specifically, the display unit 110 includes a display 111 that displays a screen for providing certain information to the user and an input 112 configured to receive the touch signal input by the user.

The display 111 may be implemented by a liquid crystal display (LCD), a light emitting diode (LED), a plasma display panel (PDP), an organic light emitting diode (OLED), a cathode ray tube (CRT), and the like.

The input 112 may be a transparent switch disposed in front of the display 111. When the display 111 displays buttons for receiving a control command from the user, the user may see the screen displayed on the display 111, simultaneously touch the input 112, and input a desired control command.

The input 112 may be implemented by a touch panel that detects the touch signal. Exemplary methods of detecting the touch signal include: a resistance film method of detecting a pressure (also referred to as a resistive method); a capacitance method of detecting static electricity generated from a human body; an ultrasound method of radiating an ultrasound onto a surface of the touch panel; and an infrared method in which a plurality of infrared sensors are arranged around the touch panel and blocking of infrared light at a contact position is detected. A method of detecting the touch signal applied to the input 112 is not limited.

When the touch signal is input through the input 112, the controller 120 determines whether the input touch signal continues for a reference time or more. When the input touch signal continues for the reference time or more, whether or not the input touch signal is a specific touch signal is determined. Then, a specific task corresponding to this specific touch signal is executed.

When the specific task is executed, the controller 120 may use other modules provided in the vehicle 100 or other devices as will be described below, or the controller 120 may autonomously perform a certain operation.

The reference time is used to distinguish a touch signal that is input by the user to select the button displayed on the display 111 from a touch signal that is input in order to execute a specific task, that is, the specific touch signal. A manufacturer or the user may appropriately set the reference time. For example, a time of 3 to 5 seconds may be set as the reference time. When 3 seconds is set as the reference time, if the input touch signal continues for 3 seconds or more, the input touch signal is determined as the specific touch signal, and a specific task corresponding thereto is executed. When the input touch signal continues for less than 3 seconds, it is determined that a button corresponding to a position in which the touch signal is input is selected in the input 112, and a task corresponding to the button is executed.

FIG. 3 is a diagram illustrating an internal configuration of a vehicle having an apparatus for performing a specific task according to an embodiment of the present disclosure, wherein a display unit is located in the vehicle.

As illustrated in FIG. 3, the display unit 110 is provided in a center fascia 11 of a dashboard 10 such that the user may see a displayed screen or input a control command while driving. The display unit 110 may display a screen related to an audio function, a screen related to a video function, a screen related to a phone function, or a screen related to a navigation function. Accordingly, the display unit 110 may also be called an audio video navigation (AVN) display.

When the user selects the audio function, the screen related to the audio function is displayed on the display unit 110, and a sound corresponding to a music file or a radio channel selected by the user is output through a speaker 142.

When the user selects the video function, the screen related to the video function, that is, a screen corresponding to a video file or a digital multimedia broadcasting (DMB) channel selected by the user, is displayed on the display unit 110, and a sound corresponding to the video file or the DMB channel is output through the speaker 142.

Further, when the user selects the navigation function, the screen related to the navigation function, that is, a screen for showing a driving path to a destination set by the user, is displayed on the display unit 110, and a sound for showing the driving path is output through the speaker 142.

As described above, the display unit 110 may be implemented by a touch screen so that the user touches the display unit 110 to input a control command for the vehicle 100. The vehicle 100 may further include a separate input unit in addition to the display unit 110.

For example, an AVN input unit 131 in the form of a hard key is provided in the center fascia 11 adjacent to the display unit 110, and may receive a control command for a basic operation such as turning the AVN on and off. A cluster input unit 132 is provided in a part of a steering wheel 12 and may receive selection information displayed on a cluster display 141a between a speed gauge 141b and an RPM gauge 141c or a control command for an operation of the AVN. Alternatively, a jog shuttle 133 provided in a center console 40 between a driver's seat 21 and a passenger's seat 22 may receive the control command or the selection information described above.

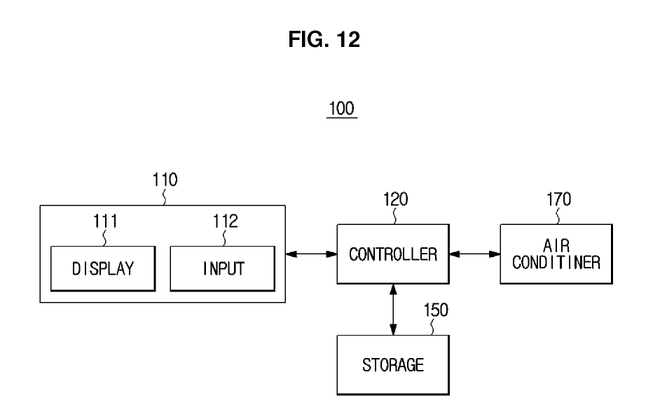

An air conditioning input unit 134 configured to receive a command for controlling a temperature in the vehicle 100 may be provided below the center fascia 11. When the user sets the temperature in the vehicle 100 through the air conditioning input unit 134, an air conditioner 170 (refer to FIG. 12) installed inside the vehicle 100 heats or cools air according to the set temperature and discharges the air via a ventilation opening 143.

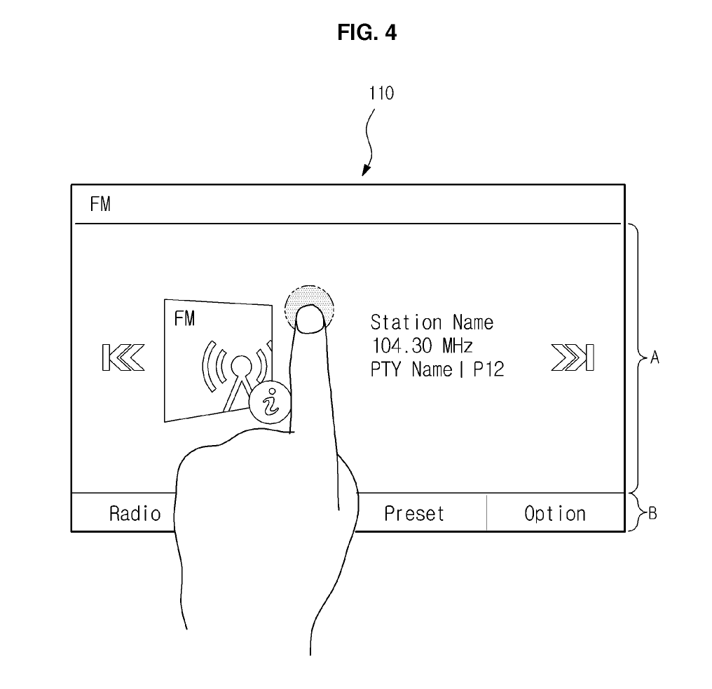

FIG. 4 is a diagram illustrating an exemplary input of a touch signal through the display unit in the vehicle according to an embodiment of the present disclosure.

As illustrated in FIG. 4, the user may input a specific touch signal by touching any area on the display unit 110 for the reference time or more. In FIG. 4 as an example, one finger is used to touch the display unit 110. However, when the number of fingers corresponds to a different task as will be described below, the display unit 110 may be touched with the number corresponding to a desired task.

When the user inputs the specific touch signal, any screen may be displayed on the display unit 110. As illustrated in FIG. 4, although the screen related to the audio function, and more specifically, a screen related to a radio channel selection, is displayed on the display unit 110 and a button for the radio channel selection is displayed on the screen. When the touch signal continues for the reference time or more is input, the controller 120 may recognize this signal as the specific touch signal.

In other words, even when an area in which the specific touch signal is input by the user overlaps an area in which the button for the radio channel selection is displayed, the controller 120 may recognize the input touch signal as the specific touch signal for executing a specific task rather than the touch signal for the radio channel selection.

The area in which the specific touch signal is input may also be limited in the display unit 110. As illustrated in FIG. 4, in the display unit 110, a screen related to the radio channel selection is displayed on area A, and a status bar is displayed on area B. In this case, the area in which the specific touch signal is input is limited to the area A in the display unit 110. Therefore, it is possible to prevent an error between a touch signal for a state change and a touch signal for executing a specific task.

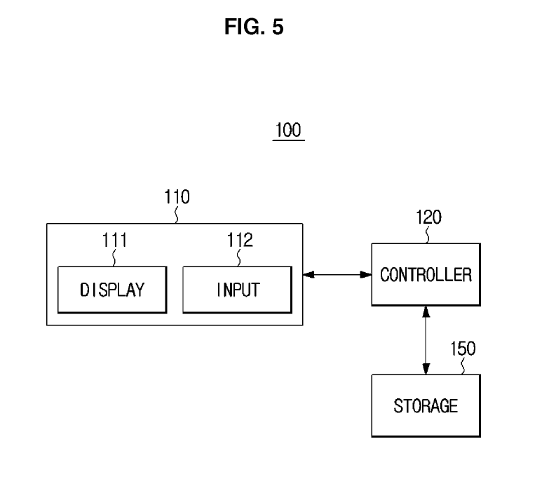

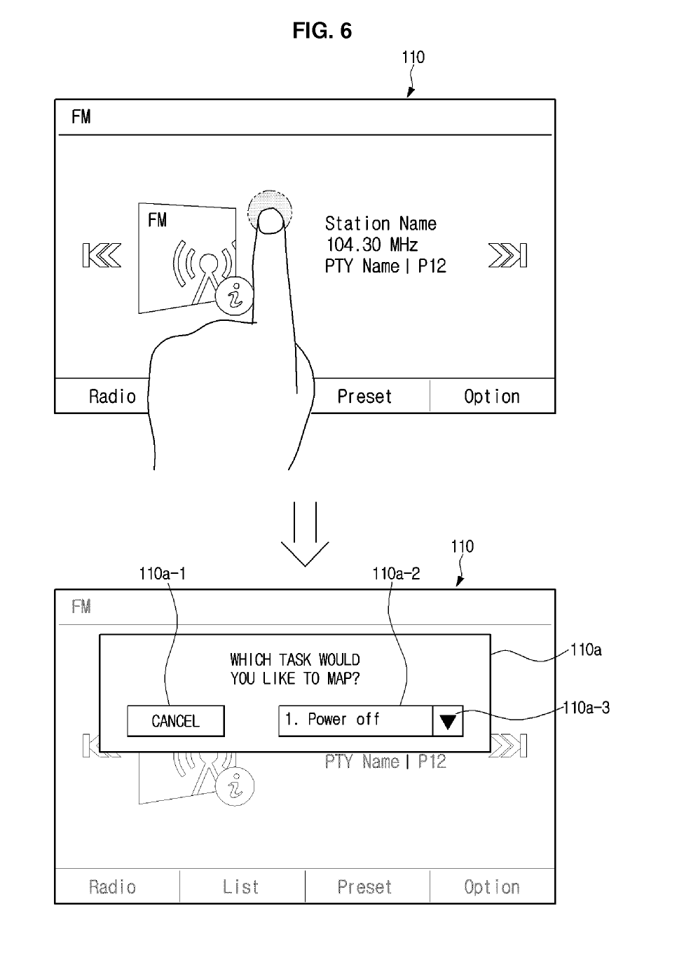

FIG. 5 is a control block diagram of an apparatus for performing a specific task of a vehicle according to an embodiment of the present disclosure in which a specific touch signal is mapped with a specific task in the vehicle. FIGS. 6 to 10 are diagrams illustrating exemplary screens displayed on the display unit when the specific touch signal is mapped with the specific task.

As illustrated in FIG. 5, the apparatus for performing a specific task of the vehicle 100 according to the embodiment of the present disclosure further includes a storage 150. The storage 150 may include at least one memory device capable of inputting and outputting information such as a hard disk, a flash memory, a random access memory (RAM), and an optical disc drive.

The storage 150 may store information on the specific touch signal and the specific task corresponding thereto. When the specific touch signal is input, the controller 120 may execute the specific task corresponding to the specific touch signal based on the information stored in the storage 150.

Alternatively, mapping the specific touch signal with the specific task may be performed by the user. For example, when the user touches any area on the display unit 110 for the reference time or more as illustrated in FIG. 6 (a), the controller 120 may display a setting popup window 110a for mapping the specific task on the display unit 110 as illustrated in FIG. 6(b).

The setting popup window 110a includes a cancel button 110a-1 for canceling the mapping and buttons 110a-2 and 110a-3 for selecting the specific task. When the user selects the cancel button 110a-1, the setting popup window 110a disappears. When the user selects the power off button 110a-2, power off is set for the specific task corresponding to the specific touch signal. That is, the controller 120 maps the specific touch signal with the power off and stores information thereof in the storage 150. Here, the power off may be power off of all AVN functions or power off of any function among them.

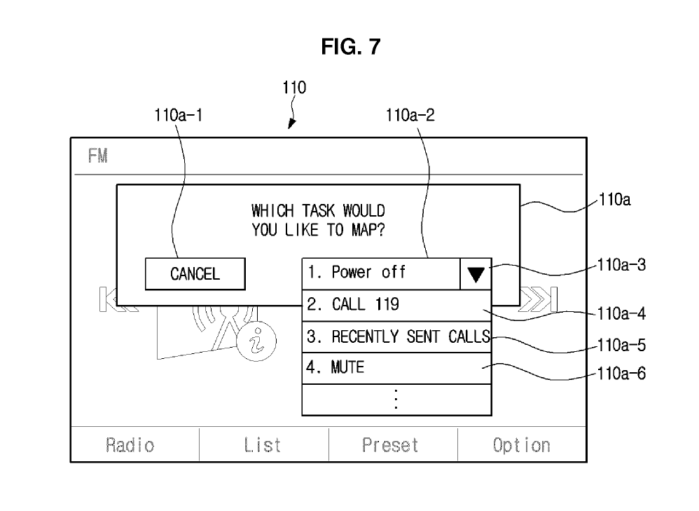

As illustrated in FIG. 7, when the user selects the drop down button (110a-3), buttons showing a list of tasks that can be mapped with the specific touch signal are displayed on the display unit 110, for example, a 911 call button (110a-4), a recently sent call button (110a-5), a mute button 110a-6, and the like.

The user may select the button for the task to be mapped with the specific touch signal. The controller 120 sets the selected task as the specific task corresponding to the specific touch signal and stores information thereof in the storage 150.

Selection of each button displayed on the display unit 110 may be performed by touching the input 112 or may be performed by manipulating other input units 131, 132, and 133 described with reference to FIG. 3.

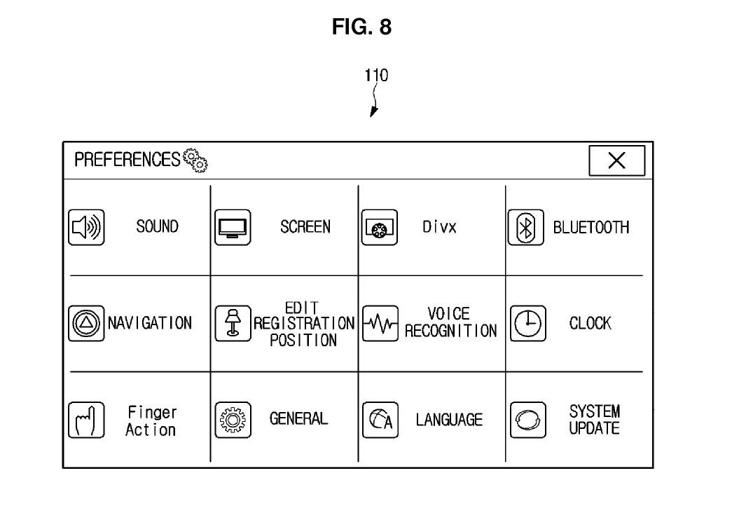

Alternatively, as illustrated in FIG. 8, the specific touch signal may be mapped with the specific task by selecting a separate setting menu. Hereinafter, an embodiment in which a specific task is differently set according to the number of fingers will be described with reference to FIGS. 8 to 10.

As illustrated in FIG. 8, the user may set various preferences necessary for executing the AVN function in a preference setting menu. The preference setting menu includes finger action setting that can map the specific touch signal with the specific task.

When the user selects the preference setting menu, buttons corresponding to configurable items may be displayed on the display unit 110. Among them, a button corresponding to the finger action setting may also be included. By selecting a button corresponding to a desired item from among the buttons displayed on the display unit 110, the user may set preferences of the desired item.

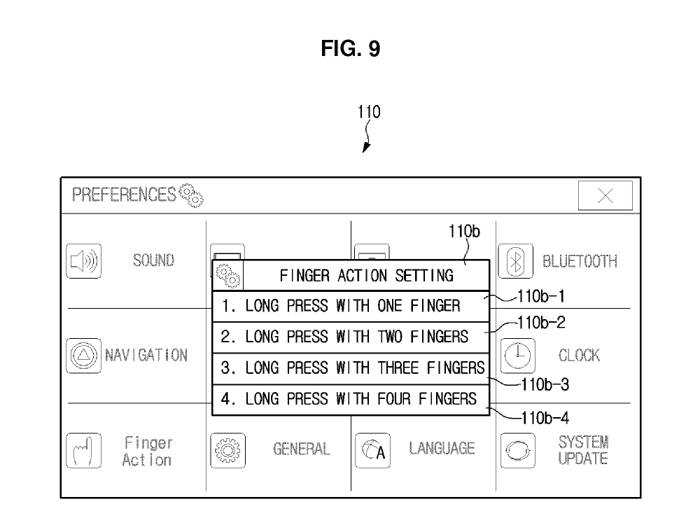

When the user selects the finger action setting, a setting popup window 110b for the finger action setting is displayed on the display unit 110, as illustrated in FIG. 9.

The setting popup 110b illustrated in FIG. 9 includes a button (110b-1) for setting a specific task corresponding to a touch signal of one finger, a button (110b-2) for setting a specific task corresponding to touch signals of two fingers, a button (110b-3) for setting a specific task corresponding to touch signals of three fingers, and a button (110b-4) for setting a specific task corresponding to touch signals of four fingers.

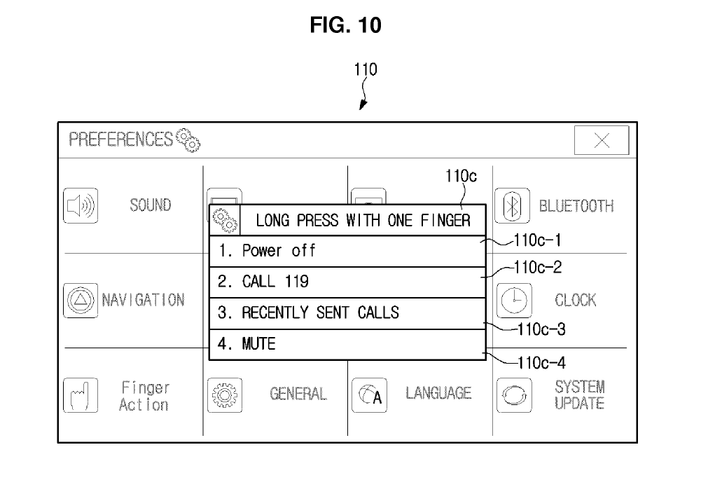

As illustrated in FIG. 10, when the user selects the button (110b-1) for setting a specific task corresponding to a touch signal of one finger, a setting popup window 110c, which includes buttons 110c-1, 110c-2, 110c-3, and 110c-4 showing a list of tasks that can be mapped with the touch signal of one finger, is displayed on the display unit 110. By selecting a button for a desired task, the user may map the selected task with the touch signal of one finger.

The user may map the specific task with each number of fingers, or map the specific task with only a certain number of fingers. Also, different tasks or the same task may be mapped with the corresponding number of fingers. For example, calling 911 may be mapped with a touch signal of one finger, and recently sent calls may be mapped with a touch signal of two fingers. Also, calling 911 may be mapped with both of the touch signal of one finger and the touch signal of two fingers.

Since the number of touch signals differs according to the number of fingers that input the touch signals, the controller 120 may determine the number of fingers based on the number of input touch signals. Accordingly, mapping the specific task with each number of fingers means that the specific task is mapped with each number of touch signals.

Specifically, if the number of touch signals input is one, it may be determined that the touch signal of one finger is input. When the number of touch signals input is two, it may be determined that the touch signal of two fingers is input.

Calling 911, recently sent calls, power off, and mute described above are only examples of the specific tasks that can be mapped with the specific touch signals in the embodiment of the present disclosure. Kinds of the specific task that can be mapped with the specific touch signal are not limited in the embodiment of the present disclosure. Hereinafter, examples of a detailed task executed when the specific touch signal is input will be described.

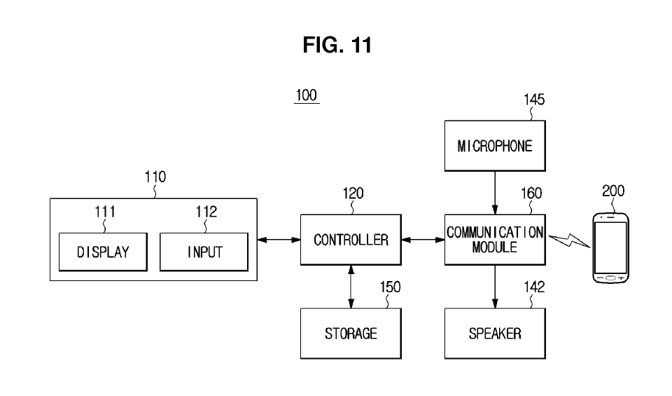

FIG. 11 is a control block diagram of an apparatus for performing a specific task of a vehicle according to an embodiment of the present disclosure for making a call using a mobile communication terminal in the vehicle.

As illustrated in FIG. 11, the apparatus for performing a specific task of the vehicle 100 may further include: a communication module 160 configured to connect a mobile communication terminal 200 and the vehicle 100; and a microphone 145 configured to receive a voice of the user and transmit the voice to the mobile communication terminal 200. A speaker 142 outputs the voice of a partner received from the mobile communication terminal 200 into the vehicle 100.

The communicator 160 connects the vehicle 100 and the mobile communication terminal 200, and may include a Bluetooth module or a WiFi module according to communication methods. For example, when the communicator 160 connects the vehicle 100 and the mobile communication terminal 200 according to a Bluetooth method, the communicator 160 may include a Bluetooth baseband that is responsible for Bluetooth specification communication and a radio frequency (RF) switch configured to control transmitting and receiving of wireless data.

The mobile communication terminal 200 may be located inside the vehicle 100 or located within a certain distance from the vehicle 100, and may be paired with the controller 120.

When the vehicle 100 and the mobile communication terminal 200 are connected by the communication module 160, a screen for receiving and sending calls or texts through the mobile communication terminal 200 may be displayed on the display unit 110. For example, in order to make a call, the user manipulates the input 112 or the other input units 131-133 such that a screen (a phone number list or a dial button) for making a call is displayed on the display unit 110. By manipulating the input 112 or the other input units 131-133 again, the user calls a desired phone number.

However, when a task of calling a predetermined phone number is mapped with the specific touch signal and stored in the storage 150, the user may input the specific touch signal to the input 112 and call the predetermined phone number without a plurality of steps to make a call.

For example, when calling 911 is mapped with the touch signal of one finger, if the user touches any area of the input 112 with one finger for the reference time or more, the controller 120 determines that the specific touch signal is input and calls 911 using the mobile communication terminal 200 connected through the communication module 160. In this case, 911 can be called with one touch without complex steps during a traffic accident or the like for a passenger. Therefore, it is possible to quickly cope with emergency situations.

The user may freely set the predetermined number. In addition to 911, any number, such as a family number, an insurance company number, an emergency service number, and the like, may be set to correspond to the specific touch signal according to the user convenience or as necessary. Also, different numbers may be set for the corresponding number of fingers.

FIG. 12 is a control block diagram of an apparatus for performing a specific task of a vehicle according to an embodiment of the present disclosure that can control temperature in the vehicle.

As illustrated in FIG. 12, the apparatus for performing a specific task of the vehicle 100 may further include the air conditioner 170 capable of controlling a temperature therein. The controller 120 controls the air conditioner 170 such that the temperature in the vehicle 100 is controlled. The air conditioner 170 may heat or cool an inside of the vehicle 100. Specifically, the air conditioner 170 may include: a condenser configured to condense and liquefy a cooling medium; an evaporator configured to vaporize the liquefied cooling medium; a compressor configured to compress the cooling medium; an indoor and outdoor air door configured to selectively discharge or introduce indoor air or outdoor air of the vehicle 100; a ventilator configured to send the air introduced through the indoor and outdoor air door to the evaporator; a heater core configured to regulate a temperature of the air introduced into the vehicle 100; a cooling water line configured to cool the heater core; a temperature regulating door provided between the evaporator and the heater core and configured to control a flow of the air passing the evaporator to the heater core; the ventilation opening 143 configured to introduce the air passing the evaporator or the heater core into the vehicle 100; and the like.

Since the air conditioner included in the vehicle 100 is well known technology, detailed description thereof will be omitted.

In order to control the temperature in the vehicle 100 using the air conditioner 170, the user needs to manipulate the air conditioning input unit 134 provided in the center fascia 11 as illustrated in FIG. 3. However, manipulating the air conditioning input unit 134 while driving may interfere with safe driving. When the weather is very cold or very hot, the temperature in the vehicle 100 needs to be rapidly controlled to a desired temperature as soon as the user gets in the vehicle 100.

When a task of controlling the air conditioner 170 according to a predetermined temperature is mapped with the specific touch signal and stored in the storage unit 150, if the user inputs the specific touch signal to the input 112, the control unit 120 may control the air conditioning device 170 such that the temperature in the vehicle 100 becomes the predetermined temperature.

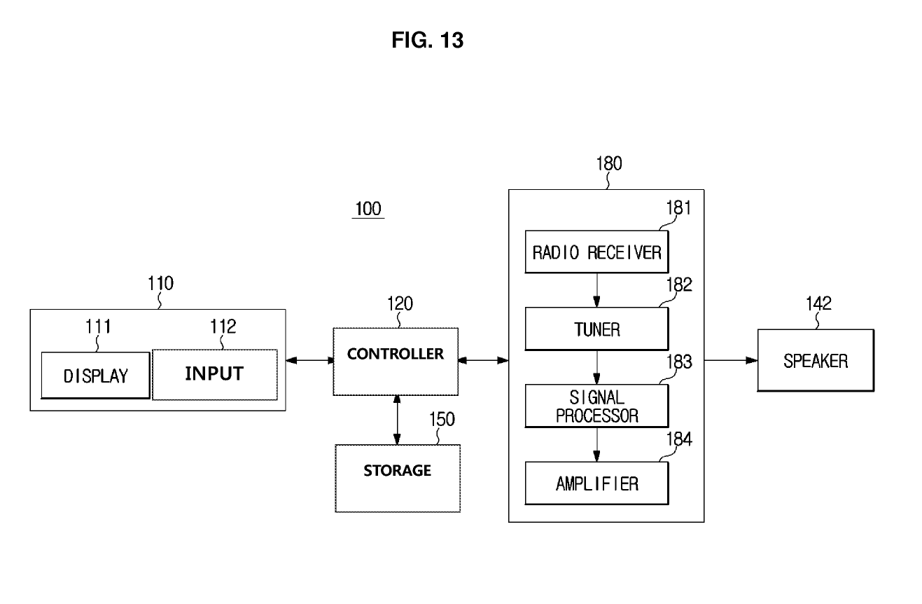

FIG. 13 is a control block diagram of an apparatus for performing a specific task of a vehicle according to an embodiment of the present disclosure that can output radio in the vehicle.

As illustrated in FIG. 13, the apparatus for performing a specific task of the vehicle 100 may further include a radio module 180 that can receive radio waves and output the waves through the speaker 142. The radio module 180 includes: a radio receiver 181 configured to receive the radio waves transmitted from a broadcast station; a tuner 182 configured to separate the waves corresponding to a desired channel from the received waves or set apart the waves of a desired frequency; a signal processor 183 configured to separate a sound signal from the separated waves; and an amplifier 184 configured to amplify the separated sound signal. The amplified sound signal may be output through the speaker 142.

In order to listen to the desired channel, the user needs to manipulate the input 112 or the other input units 131-133, turn the audio function of the AVN on, input the desired channel, and the like. The controller 120 may control the tuner 182 such that waves corresponding to the channel input by the user through the input unit are separated.

However, when a task of outputting the desired radio channel is mapped with the specific touch signal and stored in the storage 150, the radio module 180 may output the radio channel desired by the user through the speaker 142 when the user merely inputs the specific touch signal to the input 112. That is, when the specific touch signal is input, the controller 120 controls the tuner 182 such that waves corresponding to a predetermined channel are separated, and the radio is output to correspond to the predetermined channel through the speaker 142.

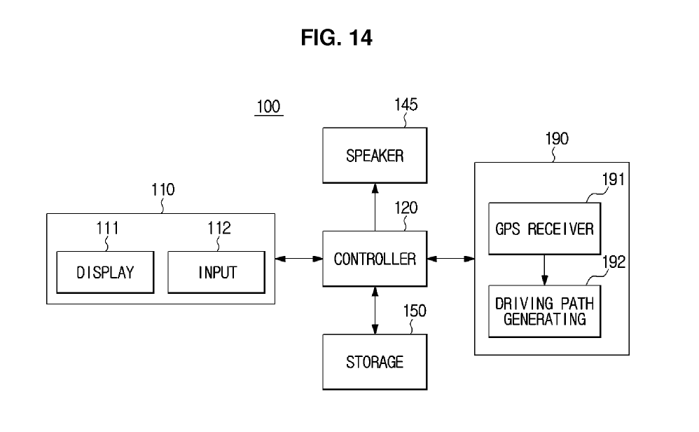

FIG. 14 is a control block diagram of an apparatus for performing a specific task of a vehicle according to an embodiment of the present disclosure that performs a navigation function in the vehicle.

As illustrated in FIG. 14, the apparatus for performing a specific task of the vehicle 100 may further include a navigator 190 that has a GPS receiver 191 configured to receive a current position of the vehicle 100 from GPS satellites and a driving path generator 192 configured to generate a driving path from a departure position to a destination.

In order to receive driving path guidance to a destination using the navigator 190, the user needs to manipulate the input 112 or the other input units 131-133, turn the navigation function of the AVN on, input information on destination setting, and the like.

However, when a task of showing a driving path to a predetermined destination is mapped with the specific touch signal and stored in the storage 150, when the user merely inputs the specific touch signal to the input 112, the navigator 190 may generate a driving path to a predetermined destination, and the controller 120 may guide the vehicle 100 according to the generated driving path.

In order to guide the vehicle 100 according to the driving path, the controller 120 may display a guide screen, in which the driving path and the current position of the vehicle 100 are overlaid and displayed on a map on a certain area including the current position, on the display 111, and a guide sound may also be output together through the speaker 142.

According to FIG. 3, the screen related to the audio function, the screen related to the video function, the screen related to the phone function, or the screen related to the navigation function, that is, an audio screen, a video screen, a phone screen, or a navigation screen, may be displayed on the display unit 110. The specific touch signal may also be mapped with a task of displaying any of the screens on the display unit 110.

Accordingly, when the specific touch signal is input, the controller 120 may display at least one of the screens on the display unit 110.

Further, in order to prevent the specific touch signal being unintentionally input, the controller 120 may perform a lock function. The lock function may also be selected in the preference setting menu described above. When the lock function is selected, even when the specific touch signal is input, a task mapped thereto is not executed.

Turning on the lock function may also be mapped with the specific touch signal. For example, when the touch signal of one finger or two fingers is mapped with the specific task, the touch signal of three fingers may be mapped with turning on the lock function. Accordingly, when the user inputs the touch signal of three fingers and the lock function is turned on, the specific task mapped thereto may not be executed whether the specific touch signal of one finger, two fingers, or three fingers is input or not. In addition, turning off the lock function may be selected in the preference setting menu.

Hereinafter, a method of controlling an apparatus for performing a specific task of a vehicle according to an embodiment of the present disclosure will be described. The apparatus of the vehicle 100 according to the aforementioned embodiment may be applied to the method according to an embodiment of the present disclosure. The drawings and descriptions of the vehicle 100 may be applied to the method of controlling the vehicle.

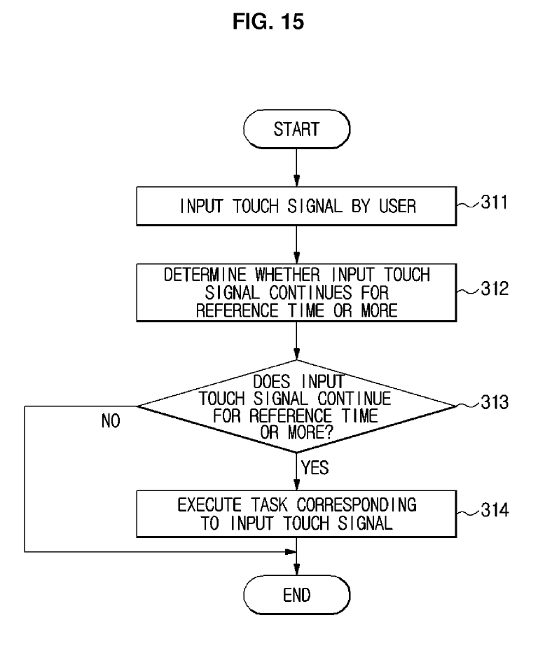

FIG. 15 is a flowchart illustrating a method of controlling an apparatus for performing a specific task of a vehicle according to an embodiment of the present invention.

As illustrated in FIG. 15, a touch signal is input by a user (311), and whether or not the input touch signal continues for a reference time or more is determined (312). The reference time is used to distinguish a touch signal that is input by the user to select a button displayed on the display 111 from a touch signal which is input in order to execute a specific task. The reference time may be appropriately set by a manufacturer or the user.

When the input touch signal continues for the reference time or more (Yes in 313), the input touch signal is determined as the specific touch signal and a task corresponding thereto is executed (314). Here, the specific touch signal refers to a touch signal that is set for the corresponding specific task. For example, when a task of calling 911 is set to correspond to the touch signal of one finger for 3 seconds or more, the touch signal of one finger for 3 seconds or more is the specific touch signal and the task of calling 911 is the specific task.

A plurality of specific touch signals may be set for each number of fingers. For example, when the reference time is 3 seconds, the specific touch signal may include a touch signal of one finger for 3 seconds or more, a touch signal of two fingers for 3 seconds or more, a touch signal of three fingers for 3 seconds or more, and the like.

The specific task may include any task that can be performed by the vehicle 100 according to a user manipulation.

The specific touch signals and types and the number of specific tasks corresponding thereto are not limited, and may be set by the manufacturer or the user. Hereinafter, an embodiment in which these are set by user will be described.

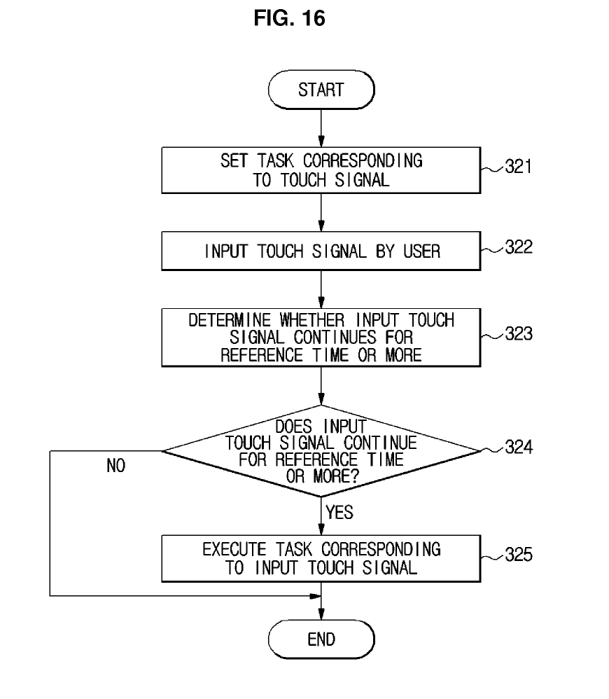

FIG. 16 is a flowchart in which a specific touch signal is mapped with a specific task by a user in the method of controlling an apparatus for performing a specific task of a vehicle according to an embodiment of the present disclosure.

As illustrated in FIG. 16, a task corresponding to a touch signal is set first (321). That is, a specific touch signal and a specific task are mapped and stored. For example, the specific touch signal may be mapped with the specific task: such as, calling a predetermined number; outputting a reference channel on the radio; controlling a temperature in the vehicle 100 according to a predetermined temperature, power off, showing a driving path to a predetermined destination; and the like, and may be stored.

As described above, a plurality of specific touch signals may be set for each number of fingers. Different tasks or the same task may be mapped for each number of fingers. Detailed description of mapping the specific touch signal with the specific task is the same as those in FIGS. 5 to 13.

When the touch signal is input by the user (322), whether or not the input touch signal continues for a reference time or more is determined (323). When the input touch signal continues for the reference time or more (Yes in 324), a task corresponding to the input touch signal is executed (325).

According to the vehicle and the method of controlling the same described above, the specific touch signal input by the user is recognized, and the specific task corresponding thereto is executed. Therefore, it is possible to reduce a manipulation load of the user and ensure safe driving at the same time.

When calling 911 or the like is set as the specific task, it is possible to quickly cope with emergency situations with a single touch input in the event of a traffic accident or a critical situation for a patient.

In the apparatus for performing a specific task of the vehicle and the method of controlling the same according to the embodiments of the present disclosure, a task that is frequently used by the user or necessary for emergency situations is immediately executed by recognizing a simple touch signal. Therefore, it is possible to reduce a manipulation load of the user.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. An apparatus for performing a specific task of a vehicle, comprising:
an input configured to receive a touch signal inputted by a user; and
a controller configured to determine whether the receiving of the input touch signal continues for a reference time or more, and execute the specific task corresponding to the input touch signal when the receiving of the input touch signal continues for the reference time or more.

2. The apparatus according to claim 1, further comprising:
a display,
wherein the input includes a touch screen configured to receive the touch signal.

3. The apparatus according to claim 1, further comprising:
a storage configured to store information on a specific touch signal and the specific task corresponding thereto.

4. The apparatus according to claim 1, further comprising:
a communication module configured to connect the controller and a mobile communication terminal,
wherein the controller executes a communication specific task corresponding to the input touch signal using the mobile communication terminal.

5. The apparatus according to claim 4,
wherein the communication specific task corresponding to the input touch signal includes calling a predetermined number.

6. The apparatus according to claim 1, further comprising:
an air conditioner configured to control a temperature in the vehicle,
wherein the controller executes a temperature specific task corresponding to the input touch signal using the air conditioner.

7. The apparatus according to claim 6,
wherein the temperature specific task corresponding to the input touch signal includes controlling the temperature in the vehicle to a set temperature.

8. The apparatus according to claim 1, further comprising:
a radio module that includes;
a receiver configured to receive radio waves,
a tuner configured to separate radio waves corresponding to a specific channel from the received radio waves,
a signal processor configured to separate a sound signal from the separated radio waves;
an amplifier configured to amplify the separated sound signal; and
a speaker configured to output the sound signal separated from the radio waves corresponding to the specific channel,
wherein the controller executes a radio specific task corresponding to the input touch signal using the radio module.

9. The apparatus according to claim 8,
wherein the radio specific task corresponding to the input touch signal includes controlling the tuner such that radio waves corresponding to a predetermined channel are separated.

10. The apparatus according to claim 1, further comprising:
a navigator that includes;
a global positioning system (GPS) receiver configured to receive a current position of the vehicle from GPS satellites, and
a driving path generator configured to generate a driving path from a departure position to a destination,
wherein the controller guides the vehicle according to the generated driving path and executes a driving specific task corresponding to the input touch signal using the driving path generator.

11. The apparatus according to claim 10,
wherein the driving specific task corresponding to the input touch signal controls to generate a driving path from the departure position to a predetermined destination and to guide the vehicle according to the generated driving path.

12. The apparatus according to claim 2,
wherein the display displays at least one of an audio screen, a video screen, and a navigation screen, and
the controller controls the display such that a display specific task corresponding to the input touch signal is executed.

13. The apparatus according to claim 12,
wherein the display specific task corresponding to the input touch signal displays at least one screen of the audio screen, the video screen, and the navigation screen.

14. The apparatus according to claim 1,
wherein the controller differently maps a task according to the number of input touch signals.

15. A method of controlling an apparatus for performing a specific task of vehicle, comprising steps of:
receiving a touch signal inputted by a user;
determining whether the receiving of the input touch signal continues for a reference time or more; and
executing a task corresponding to the input touch signal when the receiving of the input touch signal continues for the reference time or more.

16. The method according to claim 15,
wherein the touch signal is inputted through a touch screen.

17. The method according to claim 16,
wherein the task corresponding to the input touch signal includes calling a predetermined number using a mobile communication terminal that is paired with the vehicle, and
the predetermined number includes at least one of 911, the most recently called number, and an insurance company number.

18. The method according to claim 16,
wherein the task corresponding to the input touch signal includes a task of controlling a temperature in the vehicle to a predetermined temperature, a task of outputting the radio corresponding to a predetermined channel through a speaker included in the vehicle, a task of generating a driving path from a departure position to a predetermined destination and guiding the vehicle according to the generated driving path, or a task of displaying at least one predetermined screen of an audio screen, a video screen, and a navigation screen on the display.

19. The method according to claim 16, further comprising a step of:
mapping and storing a specific touch signal with a specific task,
wherein when the input touch signal continues for the reference time or more, it is determined as the specific touch signal.

20. The method according to claim 18,
wherein the step of mapping and storing the specific touch signal with the specific task includes a step of, according to the number of touch signals forming the specific touch signal, differently mapping a specific task corresponding thereto.
